(19) United States
(12) Patent Application Publication
(10) Pub. No.: US 2013/0290657 A1
(43) Pub. Date: Oct. 31, 2013

(54) STORING DATA IN CONTAINERS

(71) Applicant: Nick Baciu, Colorado Springs, CO (US)

(72) Inventor: Nick Baciu, Colorado Springs, CO (US)

(21) Appl. No.: 13/456,946

(22) Filed: Apr. 26, 2012

(51) Int. Cl. G06F 12/00

(52) U.S. Cl. 711/161; 711/E12.001

(57) ABSTRACT

Methods and apparatus to store data are disclosed. An example method includes establishing a plurality of containers for storing data representative of a list of records to be displayed on a device; and loading a first segment of the list of records into first and second ones of the containers by alternating between loading the first container with first data and loading the second container with second data until the first segment is loaded into the first and second containers.

### BACKGROUND

Computing platforms enable users to access, extract and review records of information stored in, for example, one or more databases. In some instances, the records are presented to the user on a display device in the form of a list. To present the records on the display device, the computing platforms sometimes load the list into a memory, such as a cache. Different segments of the list are retrieved from the cache for rendering on the display device as the user navigates (e.g., scrolls) through the displayed list.

### BRIEF DESCRIPTION OF THE DRAWINGS

FIG. 1 illustrates an example storage manager.

FIG. 2 illustrates an example computing device including an example storage manager.

FIG. 3 illustrates an example loading technique of an example loader.

FIG. 4A illustrates a first example navigation of a sorted list stored in example containers.

FIG. 4B illustrates a second example navigation of a sorted list stored in example containers.

FIG. 5 illustrates a first example adjustment of example containers.

FIG. 6 illustrates a second example adjustment of example containers

FIGS. 7-12 are flowcharts representative of machine readable instructions that may be executed to implement example storage managers.

FIG. 13 is a block diagram of an example processor platform capable of executing example machine readable instructions to implement example storage managers.

### DETAILED DESCRIPTION

Example methods, apparatus, and articles of manufacture disclosed herein enable rapid presentation of lists of records to users through the use of a plurality of data storage containers (e.g., memory locations and/or areas, registers, etc.). According to examples disclosed herein, a relatively small segment of a list of records (referred to herein as an initial segment) is loaded into first and second ones of the data storage containers to enable a quick (e.g., immediately after receiving only a small portion of the list of records) display of at least a portion of the records. In other words, example methods and apparatus disclosed herein display the initial segment of the records without waiting for the remainder of the list to be loaded and/or received.

Examples disclosed herein may improve the user experience by reducing or even substantially eliminating delays associated with waiting for display data to be loaded into, for example, memory associated with a display device (e.g., a cache from which display data is rendered). In some such examples, the initial segment of the records is retrieved in response to a search that is centered around a record requested by a user via, for example, a search or retrieval instructions. To enable the user to navigate through the records surrounding the requested record without having to wait a significant amount of time for the remainder of the list to be loaded and/or received, example methods, apparatus and/or articles of manufacture disclosed herein provide a ping-pong technique of loading the initial segment into the data storage containers. As described in greater detail below, example ping-pong technique of loading records disclosed herein include alternating between loading the first one of the containers from top to bottom and loading the second one of the containers from bottom to top. As a result of the example ping-pong loading of records disclosed herein, users are able to navigate through the list of records by, for example, scrolling through the initial segment without waiting for additional portions of the list to load before viewing the list of records.

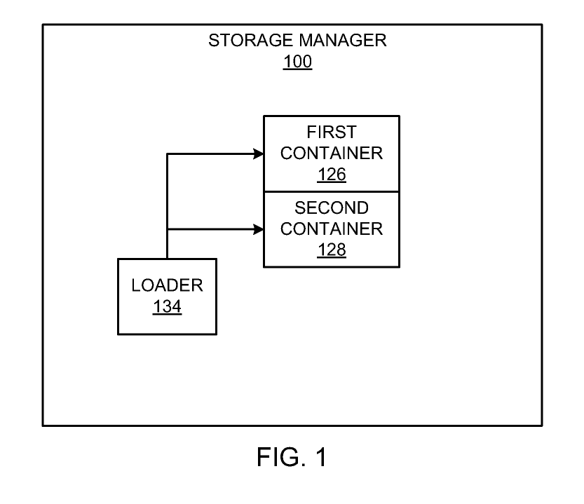

FIG. 1 illustrates an example storage manager 100. The example storage manager 100 includes a first container 126 and a second container 128. The example first and second containers 126 and 128 receive data representative of records of a list. In the illustrated example, a display of the list is to be rendered using the records stored in the first and second containers 126 and 128. The example storage manager 100 also includes a loader 134 to load a first segment of the records into the first and second containers. In the example of FIG. 1, the loader 134 loads the records into the first container in a first direction. Further, the example loader 134 of FIG. 1 loads the records into the second container in a second direction opposite the first direction. As a result, users are able to scroll through the list of records without having to wait for the list of records to be loaded.

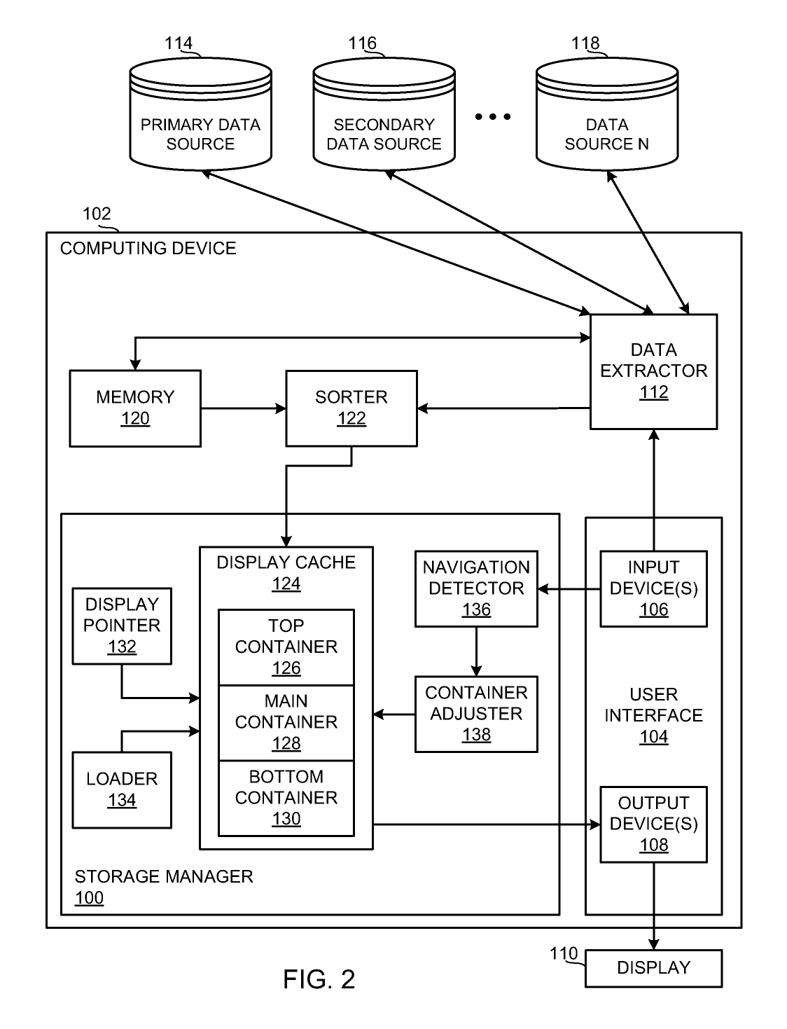

FIG. 2 illustrates an example implementation of a storage manager (e.g., the storage manager 100 of FIG. 1). The example storage manager 100 of FIG. 2 is implemented in connection with a computing device 102, such as a desktop computer, a laptop computer, a smart phone, a tablet, a server, and/or any other suitable type of computing device. The example computing device 102 of FIG. 2 includes a user interface 104 having input device(s) 106 and output device(s) 108. The input device(s) 106 of FIG. 2 include a keyboard, mouse, microphone, and/or touch screen via which a user can provide input (e.g., a search string) to the computing device 102. The output device(s) 108 of FIG. 2 include audio output device(s), video rendering device(s) (e.g., a video card) and/or any other type of presentation rendering component coupled to a display device 110. In the example of FIG. 2, the display device 110 is coupled to the computing device 102 (e.g., via a cable such as an HDMI connector). Alternatively, the display device 110 can be integral with the computing device 102.

The example user interface 104 of FIG. 2 enables a user to interact with a data extractor 112 to search for and/or retrieve data records. In some examples, the user interface 104 enables the user to utilize additional or alternative application(s) and/or device(s) to search for and/or extract data record(s), such as search engine(s) implemented at server(s) in communication with the example computing device 102. The user of the example computing device 102 of FIG. 2 enters data retrieval information (e.g., a request for data records and/or a search string) using the input device(s) 106 and corresponding instruction(s) are conveyed to the example data extractor 112. In some examples, the data extractor 112 uses the retrieval instruction(s) to access database(s) 114-118 external to the computing device 102. The example databases of FIG. 2 include a primary database 114, a secondary database 116, and any number of additional databases 118. In other words, the example data extractor 112 is capable of accessing one or more databases using the retrieval instruction(s) and retrieving, for example, a combination of data records from the plurality of databases to the example computing device 102. In some examples, depending on instructions provided to the data extractor 112 by the user of the input device(s) 106, the data extractor 112 accesses data source(s) internal to the computing device 102, such as a local memory 120 and/or removable media coupled to the computing device 102 (e.g., a flash drive coupled to a Universal Serial Bus (USB) port of the computing device 102 and/or a disk inserted into a reader of the computing device 102).

In the illustrated example of FIG. 2, when the user extracts a data record from a collection of data (e.g., a list of data records, such as list of names or a list of log entries generated by a software monitoring application) stored at one of the data sources 114-120, other data records of the collection are also retrieved by the data extractor 112. For example, when a user is reviewing log information associated with a software monitoring application (e.g., while debugging and/or designing a program or application) and the user requests (e.g., jumps to or enters a search for) a first data record, the example data extractor 112 retrieves other data records of the log file such that the requested data record can be displayed to the user as part of the data collection. That is, the example of FIG. 2 involves presenting the data records surrounding the requested data record of the collection of data records.

The example computing device 102 of FIG. 2 includes a sorter 122 to sort records received from, for example, the data extractor 112 and/or directly from the local memory 120. The example sorter 122 of FIG. 2 sorts records into list(s) according to, for example, instructions provided to the data extractor 112 in connection with the retrieval instruction(s) provided by the user, setting(s) associated with the sorter 122, type(s) of data being retrieved, etc. For example, the user can instruct the data extractor 112 to return an alphabetically sorted list of records or a chronologically (e.g., according to time stamp(s)) sorted list of records. The example sorter 122 of FIG. 2 sorts the records into list(s) in accordance with the user instruction(s) and/or settings and conveys the list(s) to a data storage device. In the illustrated example of FIG. 2, the sorter 122 conveys the list(s) of records to a display cache 124 of the example computing device 102. In some instances, the data extractor 112 does not enlist the sorter 122 to sort the retrieved records. Instead, in such instances, the example data extractor 112 and/or the local memory 120 provides unsorted records to the example display cache 124. In some examples, a sorted list is retrieved directly (e.g., without use of the sorter 122) from the local memory 120 in accordance with, for example, a request received from the user via the input device(s) 106.

While the illustrated example of FIG. 2 includes records being conveyed to the display cache 124, additional or alternative types of data storage component(s) and/or structure(s) can be used to receive, process, and/or store the records as disclosed herein. In other words, cache memory is an illustrative type of storage device that is not meant to limit the types and/or number of storage that can be managed by the example storage manager 100 of FIG. 2. The example display cache 124 of FIG. 2 enables rapid access to the records to, for example, the output device(s) 108 and, in turn, the example display device 110. In the illustrated example, the cache 124 is utilized by the example computing device 102 of FIG. 2 due to the higher speed of caches in comparison with other types of memory. The example display cache 124 of FIG. 2 may be implemented by any suitable type(s) of cache and may include any suitable number of levels.

The record(s) stored in the example display cache 124 are conveyed to the example output device(s) 108 of FIG. 2, which may be implemented by driver(s) that render representation(s) of the record(s) on the display device 110. To enable rapid rendering of the representation(s) of the record(s) on the display device 110, the example storage manager 100 of FIG. 2 establishes and manages a plurality of containers (e.g., memory locations and/or areas) in the example display cache 124. In the illustrated example of FIG. 2, the storage manager 100 establishes three containers in the display cache 124 including a top container 126, a main container 128, and a bottom container 130. While the example containers 126-130 of FIG. 2 are referred to herein as top, main and bottom containers, the terms ‘top,’ ‘main,’ and ‘bottom’ are used herein for purposes of explanation and are not limiting with respect to actual physical, numeric or other spatial locations in an address space corresponding to the example display cache 124. Rather, “top,” “main,” and “bottom” are logical names used to distinguish these locations as different without implying any particular physical arrangement.

As the records are loaded into the example containers 126-130 of FIG. 2, the display device 110 renders at least a segment of the representations of the records that includes the requested record. The size of the segment displayed on the display device 110 is limited by a finite display area designated for presentation of the records defined by, for example, a window associated with the data extractor 112. That is, the display device 110 may not be able to simultaneously display the entire list of records stored in the example containers 126-130 of FIG. 2. For example, when the list of records stored in the containers 126-130 corresponds to a plurality of log entries generated by a software monitoring application that is being reviewed by a software engineer or programmer, the number of records in the list can be in the thousands or greater. In the illustrated example, the presentation area of the display device 110 is capable of displaying a small percentage of such a list of records at a particular time.

To control and/or track which segment of the list of records is currently presented on the display device 110, the example storage manager 100 of FIG. 2 includes a display pointer 132. The example display pointer 132 of FIG. 2 is initialized to refer to the requested record that was extracted via the data extractor 112. As described in greater detail below in connection with FIG. 2, the example display pointer 132 of FIG. 2 is adjusted as the user navigates (e.g., scrolls) through the list of records to correspond to a reference position (e.g., a top position or a center position) in the segment that is currently presented on the display device 110.

The example storage manager 100 of FIG. 2 includes a loader 134 to load the records received from, for example, the data extractor 112, the sorter 122 and/or the local memory 120 into the containers 126-130. The example loader 134 of FIG. 2 loads the received list of records into the containers 126-130 such that the list is displayed on the display device 110 more quickly than previous systems. In particular, the example loader 134 of FIG. 2 loads a first, relatively small segment of the list of records (referred to herein as an initial segment) into the containers 126-130. The initial segment of the illustrated example is centered around the requested record (e.g., the record for which the user initially searched). Thus, records above the requested record in the received sorted list and records below the requested in the received sorted list are loaded as the initial segment. In some examples, the initial segment is loaded into the containers 126-130 in chunks of records having a size of, for example, fifty records of the received list. In such instances, the initial segment includes a certain number of data chunks such as, for example, ten chunks of fifty records. In some examples, the initial segment is loaded into the containers 126-130 as individual records. In such instances, the initial segment includes a certain number of records such as, for example, five hundred records. Alternatively or additionally, the size of the initial segment may be defined by a percentage (e.g., one percent) of the list of records. When the example loader 134 has loaded the initial segment into the containers 126-130, some or all (e.g., depending on the size of the display area of the corresponding portion of the display device) of the initial segment is presented on the display device 110 and the example display pointer 132 is initialized to the reference position of the initial segment. After the example loader 134 of FIG. 2 loads the initial segment into the containers 126-130, the example loader 134 loads the remaining records of the list in segments that are larger than the initial segment. In the illustrated example, the segments loaded after the initial segment have a size of one thousand records. Alternatively, the size of the segments loaded after the initial segment may be based on a percentage (e.g., ten percent) of the list of records. In some examples, the loader 134 executes a dedicated thread for loading the initial segment and one or more separate threads for loading the subsequent, larger segments of the list of records.

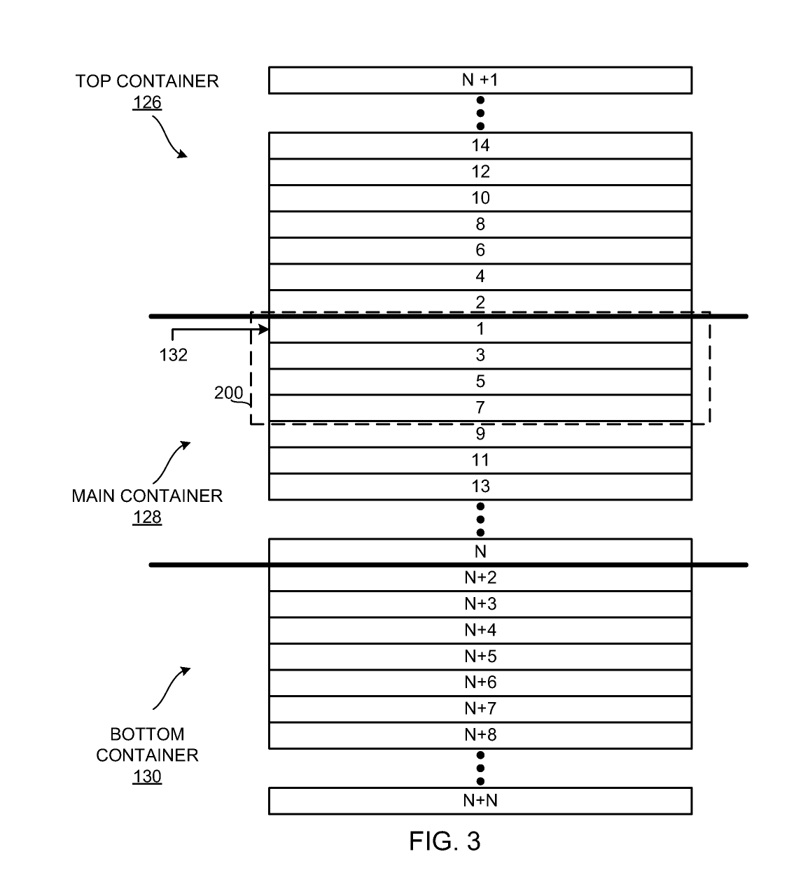

The example loader 134 of FIG. 2 loads the initial segment of the records into the main container 128 and the top container 126 using a ping-pong loading technique. FIG. 3 illustrates the example ping-pong loading technique provided by the example loader 134 of FIGS. 1 and/or 2. The order in which the example loader 134 of FIGS. 1 and/or 2 loads the records into the main and top containers 128 and 126 is represented by the numerals shown in the slots of FIG. 3. Each of the slots of FIG. 3 corresponds to an entry of the containers that stores one of the records or one chunk of records depending on, for example, whether the loader 134 is configured to load records individually or in chunks. In the illustrated example, the slots correspond to an individual record. The containers 126 and 128 can include any suitable number of slots. FIG. 3 includes the display pointer 132 that corresponds to a top position of a currently displayed portion 200 of the list of records. As shown in the illustrated example, the bottom of the top container 126 is adjacent to the top of the main container 128. Further, the bottom of the main container 128 is adjacent to the top of the bottom container 130. When the initial segment of records is loaded, the initially displayed portion 200 corresponds to the top of the main container 128, at which the requested record is loaded. In other words, the record that was initially requested by the user via the input device(s) 106 (or the chunk of data including the initially requested record) is loaded into the ‘1’ slot of the main container 128 of FIG. 3. In the illustrated example, the requested record is not found at the top of the sorted list. Instead, the record requested by the user is found in the middle of the sorted list. For example, when the sorted list is an alphabetically sorted list, the displayed portion 200 shown in FIG. 3 includes names starting with the letter ‘K,’ as a result of the user wanted to view a record beginning with the letter ‘K’. The order of the sorted list is reflected in the physical order (e.g., top to bottom arrangement shown in FIG. 3) of the slots of the containers 126-130. That is, the first record of the list (e.g., a name beginning with the letter ‘A’ in an alphabetically sorted list) is loaded above the other ones of the currently loaded records.

As shown in FIG. 3, the first record loaded by the example loader 134 (e.g., the record requested by the user in connection with the retrieval instructions described above) is loaded into the ‘1’ slot of the main container 128. The second record loaded by the example loader 134 (e.g., the record adjacent to the first record in the sorted list in an upwards direction) is loaded into the ‘2’ slot of the top container 126. The third record loaded by the example loader 134 (e.g., the record adjacent to the first record in the sorted list in a downwards direction) is loaded into the ‘3’ slot of the main container 128. The example loader 134 continues the ping-pong loading of the containers 126 and 128 until, for example, the initial segment is loaded. In other words, each time in the ping-pong loading technique that the example loader 134 is to load a record into the main container 128, the example loader 134 identifies the highest (e.g., closet to the top or beginning) available slot or entry in the main container 128 and loads the respective record into the identified slot or entry. Further, the example loader 134 of FIGS. 1 and/or 2 loads records into the top container 126 from bottom to top. In other words, each time in the ping-pong loading technique that the example loader 134 of FIGS. 1 and/or 2 is to load a record into the top container 126, the example loader 134 identifies the lowest (e.g., closest to the bottom or end) available slot or entry in the top container 126 and loads the respective record into the identified slot or entry. The highest or top position of the main container 128 is adjacent the bottom or lowest position of the top container 126. Accordingly, as the example loader 134 of FIGS. 1 and/or 2 loads the first segment of the records into the cache 124, the main container 128 is filled from a highest slot downwards, and the top container 126 is filled from a lowest slot upwards. In the illustrated example of FIG. 3, the bottom container 130 is populated after the main and top containers 128 and 126 have been loaded by the example loader 134 via the ping-pong loading technique. In the illustrated example, the slots of the bottom container 130 are filled with the remaining records from top to bottom. As described above, the loading of the slots of FIG. 3 can alternatively correspond to chunks of data being loaded in the ping pong technique. In such instances, a first chunk of data (e.g., fifty records) is loaded into the ‘1’ slot, then a second chunk of data is loaded into the ‘2’ slot, then a third chunk of data is loaded into the ‘3’ slot, etc.

The ping-pong loading technique of the loader 134 shown in FIG. 3 enables the user to scroll up or down from a position in the list (corresponding to the display pointer 134) without having to wait for more records to load. In particular, because the main container 128 is loaded by the example loader 134 from top to bottom, if the user scrolls down past the bottom of a displayed portion 200, there are records in the main container 128 that can be immediately displayed (e.g., without retrieving more records from a data source such as the local memory 120). Further, if the user scrolls up beyond the displayed portion 200, there are records in the top container 126 that can be immediately displayed (e.g., without retrieving more records). Accordingly, the user can move the displayed portion 200 (along with the display pointer 132) up and down the sorted list of records and the example loader 134 has enabled the corresponding records to be loaded into the display cache 124 such that the user does not have to wait for the scrolled-to portions of the sorted list to be loaded.

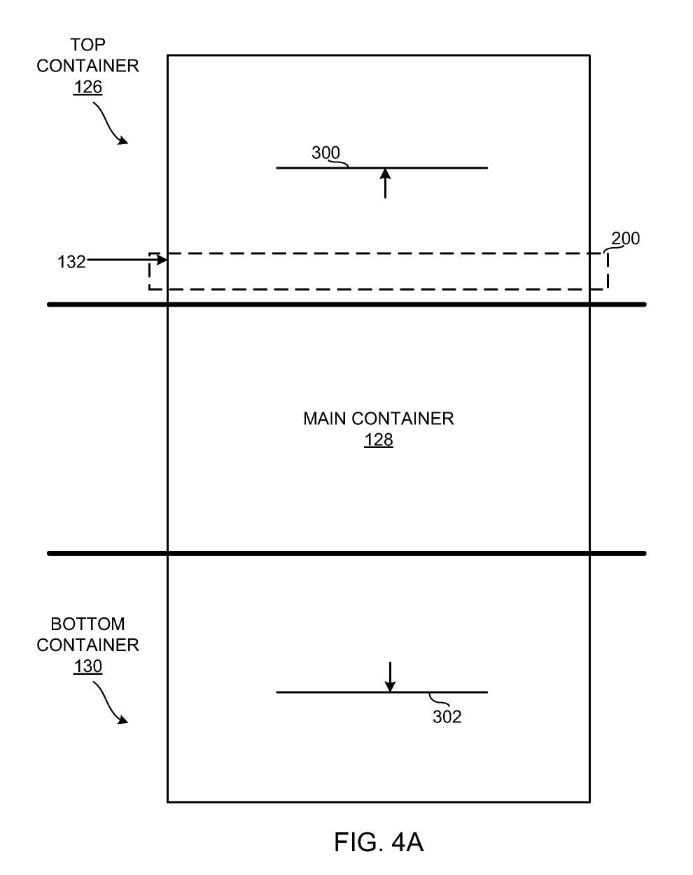

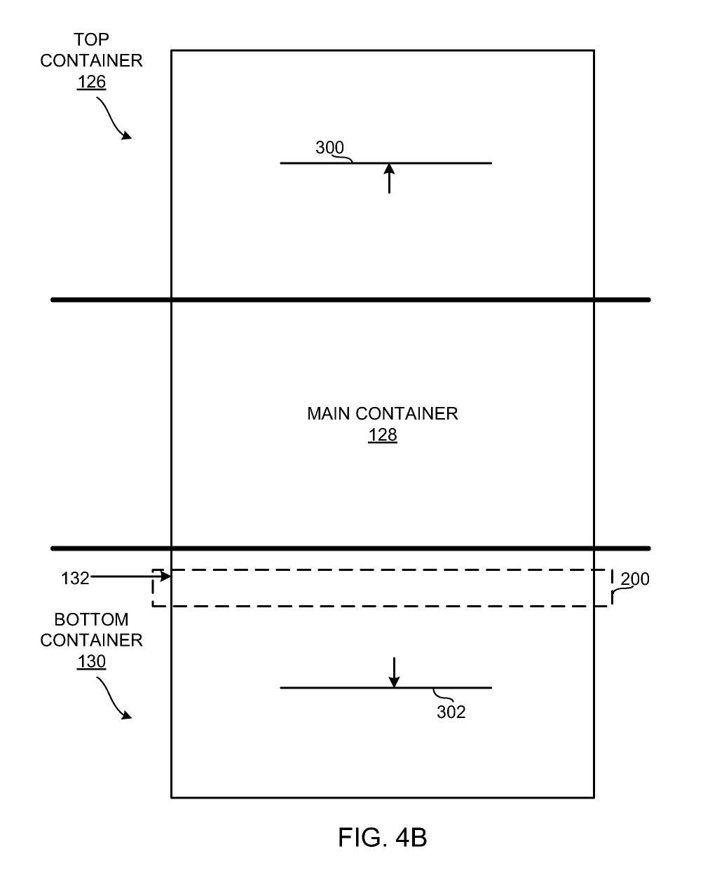

As the user scrolls up or down the sorted list stored in the containers 126-130, the display pointer 132 is adjusted accordingly to correspond to a top most one of the records displayed in the display portion 200. That is, the displayed portion 200 of the list moves up and down the slots of the containers 126-130 as the user scrolls up and down the list (e.g., via the input device(s) 106). Moving the pointer 132 does not move data in the container. FIG. 4A illustrates the displayed portion 200 of the list, as well as the display pointer 132 in a position following the user scrolling up by a certain amount (e.g., number of slots in the top container 126) from the portion shown in FIG. 3. FIG. 4B illustrates the displayed portion 200 of the list, as well as the display pointer 132 in a position following the user scrolling down by a certain amount from the portion shown in FIG. 3. As described above, the scrolling of the displayed portion 200 of the list moving from one container to another results in a smooth (e.g., immediate without waiting for loading) display of the scrolled-to portions of the list of records.

In the examples of FIGS. 4A and 4B, the displayed portion 200 of the list has been moved beyond the boundaries of the main container 128. However, the amount of slots by which the displayed portion 200 of the list has moved out of the main container 128 is not significant with respect to the overall size of the list of records. To further support a fast, smooth display of the records when, for example, the user scrolls a more significant distance in the list than is shown in FIGS. 4A and 4B, the example storage manager 100 of FIG. 2 includes a navigation detector 136 and a container adjuster 138. The example navigation detector 136 of FIG. 2 determines whether the display pointer 132 and, thus, the displayed portion 200 of the list has moved into the top container 126 by a threshold amount. As shown in FIGS. 4A and 4B, the example thresholds used by the example navigation detector 136 of FIG. 2 corresponds to certain slots in the top container 126 and the bottom container 12. The threshold slot in the top container 126 is labeled in FIGS. 4A and 4B with reference numeral 300 and referred to herein as a top container threshold. The example top threshold 300 of FIGS. 4A and 4B is a mid-point of the top container 126. However, the example top threshold 300 can be set at any suitable point within the top container 126. Further, the example navigation detector 136 of FIG. 2 determines whether the display pointer 132 and, thus, the displayed portion 200 of the list has moved into the bottom container 130 by a threshold amount, which is labeled in FIGS. 4A and 4B with reference numeral 302 and referred to herein as a bottom container threshold. As shown if FIGS. 4A and 4B, the example bottom threshold 302 used by the example navigation detector 136 of FIG. 2 corresponds to a mid-point of the bottom container 130. However, alternative thresholds are possible.

The example navigation detector 136 of FIG. 2 monitors the display pointer 132 to detect an indication of the displayed portion 200 being scrolled up to (or beyond) the top container threshold 300 or down to (or beyond) the bottom container threshold 302. In response to the navigation detector 136 determining that the displayed portion 200 has reached or exceeded one of the thresholds 300, 302, the example container adjuster 138 of FIG. 1 is triggered to alter the configuration of the containers 126-130 of the example display cache 124. As explained below, the example container adjuster 138 of FIG. 2 changes the designations of the containers 126-130 to reflect the navigation of the user into the top or bottom container 126, 130.

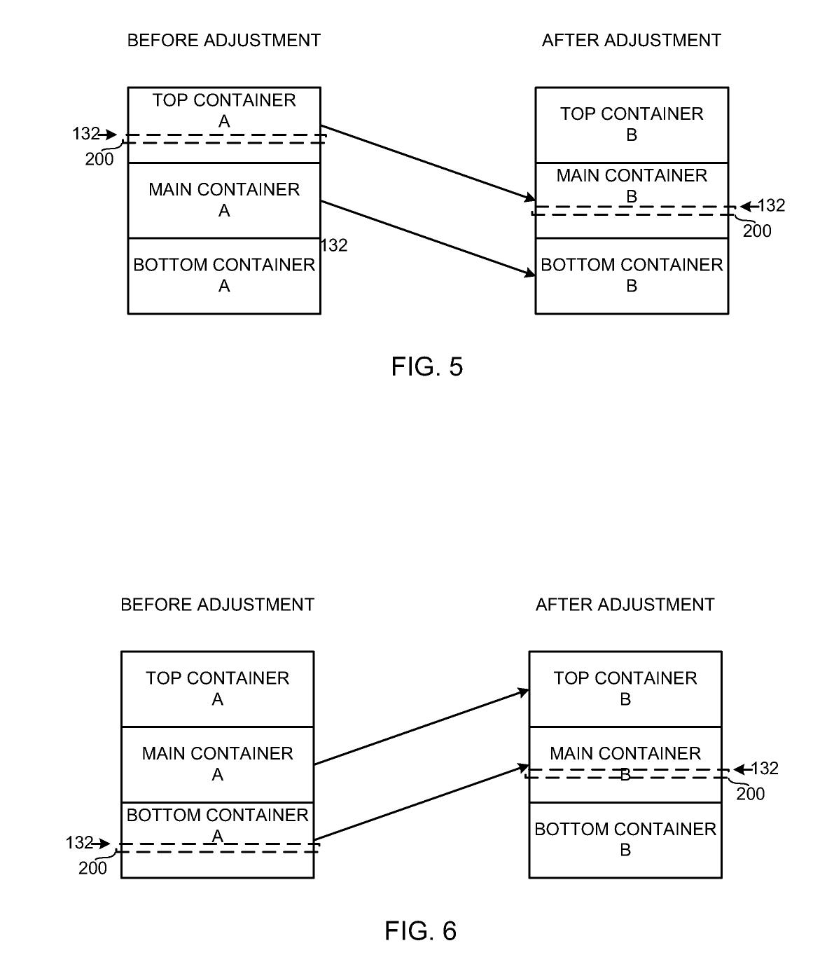

FIG. 5 illustrates an example adjustment performed by the example container adjuster 138 of FIG. 2 in response to the navigation detector 136 determining that the top container threshold 300 has been reached (or exceeded) by the display pointer 132. In the illustrated example of FIG. 5, the configuration of the containers (labeled with ‘A’) before the adjustment is shown under the ‘BEFORE ADJUSTMENT’ heading and the configuration of the containers (labeled ‘B) after the adjustment is shown under the ‘AFTER ADJUSTMENT’ heading. Top container ‘A’ of FIG. 5 corresponds to the top container 126 of FIG. 1. Main container ‘A’ of FIG. 5 corresponds to the main container 128 of FIG. 1. Bottom container ‘A’ of FIG. 5 corresponds to the bottom container 130 of FIG. 1.

As shown in FIG. 5, in response to the top container threshold 300 being reached by the display pointer 132, the example container adjuster 138 of FIG. 1 changes the designations of the containers to rearrange the configuration of the containers. In the illustrated example, the container adjuster 138 designates top container ‘A’ to become the main container ‘B’ in the display cache 124 after the adjustment. Further, the example container adjuster 138 of FIG. 2 designates the main container ‘A’ to become the bottom container ‘B’ in the display cache 124 after the adjustment. Further, the example container adjuster 138 of FIG. 2 deletes the bottom container ‘A.’ Further, the example container 138 of FIG. 2 creates a new container to become the top container ‘B’ after the adjustment. The example loader 134 of FIG. 1 loads the new top container ‘B’ such that another upwards scroll will result in a fast and smooth display of the corresponding portion of the list of records. In some examples, the top container ‘B’ is loaded from bottom to top with records of the list that were previously not loaded into the cache 124. The example display pointer 132 and the displayed portion 200 travels with the top container ‘A’ into the new main container ‘B.’ As a result, the displayed portion 200 corresponds to a mid-point of the main container ‘B’ in the example of FIG. 5.

FIG. 6 illustrates an example adjustment performed by the example container adjuster 138 of FIG. 2 in response to the navigation detector 136 determining that the bottom container threshold 302 has been reached by the display pointer 132. The containers of FIG. 6 are labeled with ‘A’ and ‘B’ in the same manner as the containers of FIG. 5. As shown in FIG. 6, in response to the bottom container threshold 302 being reached by the display pointer 132, the example container adjuster 138 of FIG. 1 designates the bottom container ‘A’ to become the main container ‘B’ in the display cache 124 after the adjustment. Further, the example container adjuster 138 of FIG. 1 designates the main container ‘A’ to become the top container ‘B’ in the display cache 124 after the adjustment. Further, the example container adjuster 138 of FIG. 2 deletes the top container ‘A.’ Further, the example container adjuster 138 of FIG. 2 creates a new container to become the bottom container ‘B’ after the adjustment. The example loader 134 of FIG. 2 loads the new bottom container ‘B’ such that another downwards scroll will result in a fast and smooth display of the corresponding portion of the list of records. In some examples, the bottom container ‘B’ is loaded from top to bottom with records of the list that were previously not loaded into the cache 124. The example display pointer 132 and the displayed portion 200 travels with the bottom container ‘A’ into the new main container ‘B.’ As a result, the displayed portion 200 corresponds to a mid-point of the main container ‘B’ in the example of FIG. 6.

While an example manner of implementing the storage manager 100 of FIG. 1 has been illustrated in FIG. 2, one or more of the elements, processes and/or devices illustrated in FIG. 2 may be combined, divided, re-arranged, omitted, eliminated and/or implemented in any other way. Further, the example display pointer 132, the example loader 134, the example containers 126-130, the example navigation detector 136, the example container adjuster 138, and/or, more generally, the example storage manager 100 of FIG. 2 may be implemented by hardware, software, firmware and/or any combination of hardware, software and/or firmware. Thus, for example, any of the example display pointer 132, the example loader 134, the example containers 126-130, the example navigation detector 136, the example container adjuster 138, and/or, more generally, the example storage manager 100 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), field programmable gate array (FPGA), etc. At least one of the example display pointer 132, the example loader 134, the example containers 126-130, the example navigation detector 136, the example container adjuster 138, and/or, more generally, the example storage manager 100 of FIG. 2 are hereby expressly defined to include a tangible computer readable medium such as computer readable storage medium (e.g., a memory, DVD, CD, Bluray, etc. storing the software and/or firmware). Further still, the example storage manager 100 of FIG. 2 may include one or more elements, processes and/or devices in addition to, or instead of, those illustrated in FIG. 2, and/or may include more than one of any or all of the illustrated elements, processes and devices.

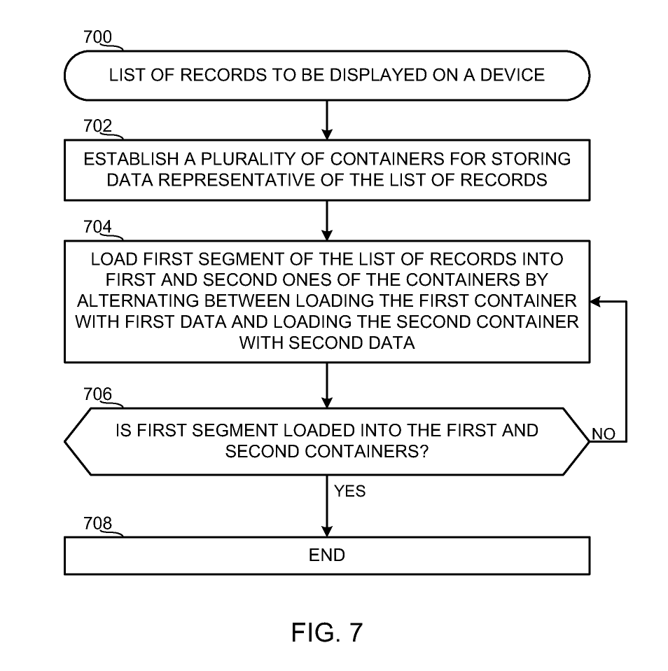

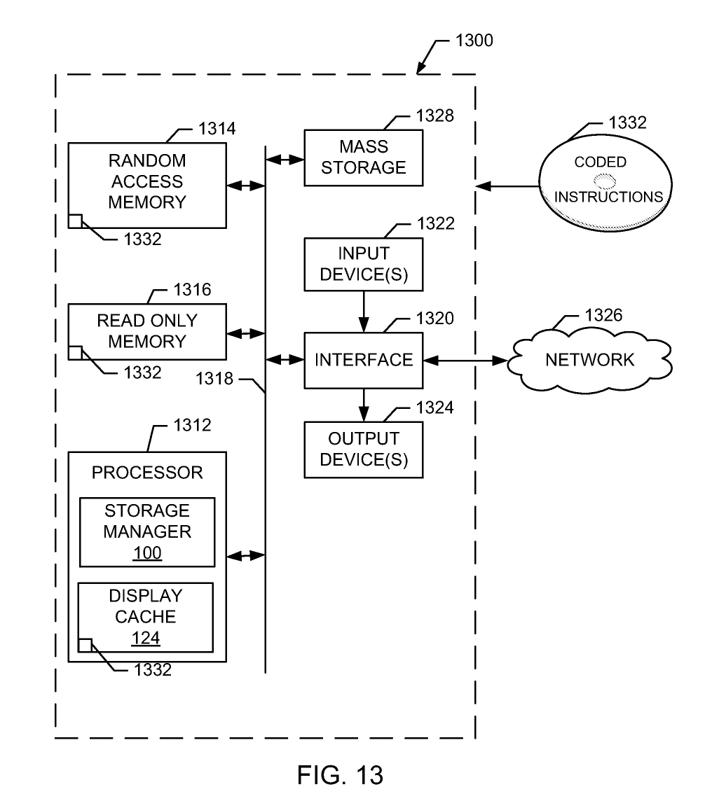

Flowcharts representative of example machine readable instructions for implementing the example storage manager 100 of FIGS. 1 and/or 2 are shown in FIGS. 7-12. In the examples of FIGS. 7-12, the machine readable instructions comprise a program for execution by a processor such as the processor 1312 shown in the example processor platform 1300 discussed below in connection with FIG. 13. The program may be embodied in software stored on a tangible computer readable medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example programs are described with reference to the flowcharts illustrated in FIGS. 7-12, many other methods of implementing the example storage manager 100 may alternatively be used. For example, the order of execution of the blocks may be changed, and/or some of the blocks described may be changed, eliminated, or combined.

As mentioned above, the example processes of FIGS. 7-12 may be implemented using coded instructions (e.g., computer readable instructions) stored on a tangible computer readable medium such as a computer readable storage medium (e.g., hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information)). As used herein, the term tangible computer readable storage medium is expressly defined to include any type of computer readable storage medium and to exclude propagating signals. Additionally or alternatively, the example processes of FIGS. 7-12 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example of FIG. 7 begins with an indication that a list of records is to be displayed on a display device (block 700). The example the example storage manager 100 of FIG. 1 establishes a plurality (e.g., three) of containers for storing data representative of the list of records to be displayed (block 702). The example loader 134 loads a first segment of the list of records into first and second ones of the established containers by alternating between loading the first container with first data and loading the second container with second data (block 704). The example loader 134 does so until the first segment of the list of records is loaded into the containers. Thus, if the first segment has been loaded into the containers (block 706), the example of FIG. 7 ends (block 708). Otherwise, control returns to block 704 and the loader 134 continues loading the first and second containers.

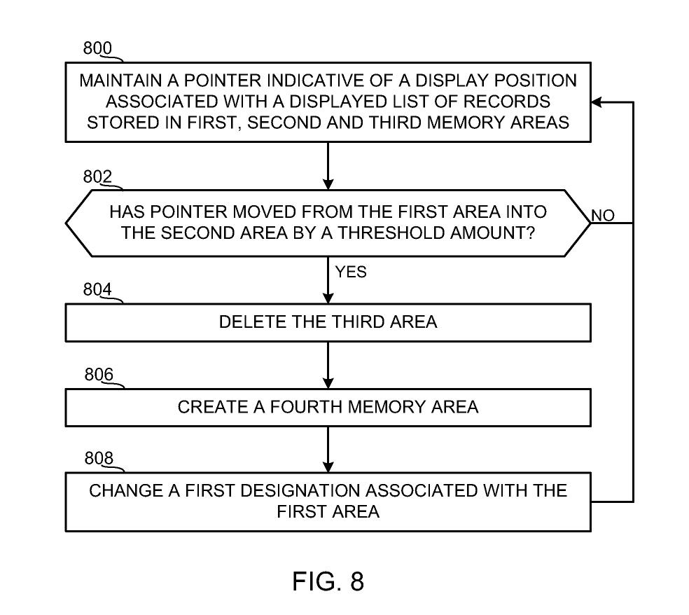

The example of FIG. 8 begins with the example storage manager 100 maintaining the display pointer 132, which is indicative of a display position associated with the displayed list of records stored in the first, second, and third containers 126-130, which are referred to as memory areas in the example of FIG. 8 (block 800). If the display pointer 132 has moved from a first one of the memory area 126-130 into a one of the memory areas 126-130 by a threshold amount (e.g., as detected by the navigation detector 136) (block 802), the example container adjuster 138 deletes a third one of the memory areas 126-130 (block 804). Further, the example container adjuster 138 creates a fourth memory area (block 806). Further, the example container adjuster 138 changes a first designation associated with the first one of the memory areas (block 808). Control then returns to block 800.

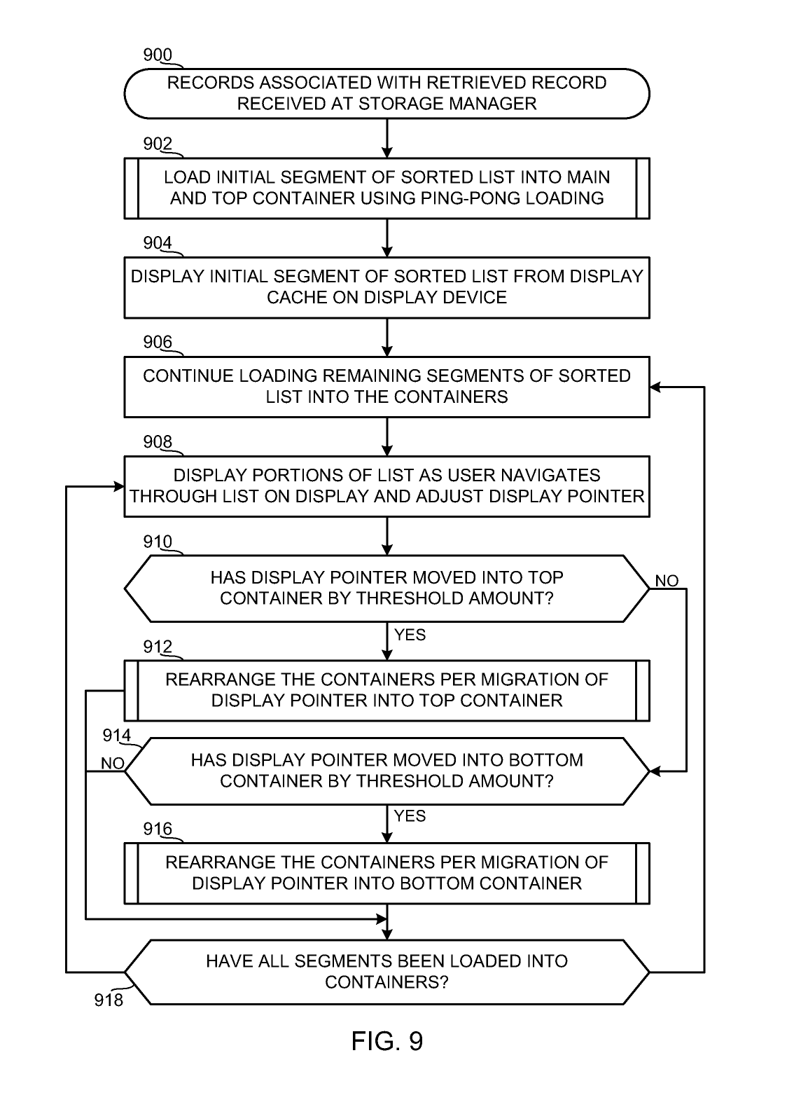

The example of FIG. 9 begins with receipt of records associated with a retrieved record at the example storage manager 100 of FIG. 1 (block 900). In the example of FIG. 9, the received records are provided to the storage manager 100 in response to a user of the example computing device 102 of FIG. 2 taking an action that causes retrieval of a record from one of the data sources 114-120 via the example data extractor 112. In the illustrated example, an initial segment of the sorted list or other type of data collection that includes the retrieved record is loaded into the example display cache 124 of FIG. 2 via the example loader 134 (block 602). In particular, the example loader 134 of FIGS. 1 and/or 2 loads the records into the main container 128 and the top container 130 of the display cache 124 using the example ping-pong technique described above (block 902).

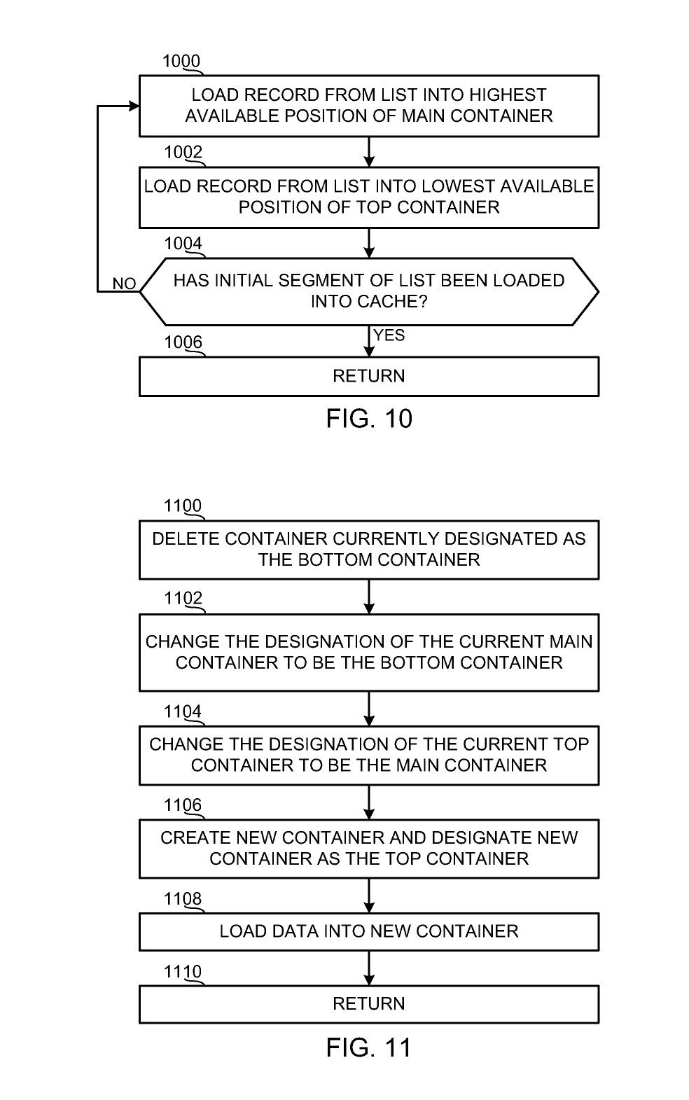

An example implementation of block 902 of FIG. 9 is illustrated in the flowchart of FIG. 10. To load the initial segment of the list into the display cache 124 such that the user can navigate (e.g., scroll) through the records via the display device 110 without having to wait significant amounts of time for further loading, the example loader 134 of FIGS. 1 and/or 2 alternates between loading the main container 128 and the top container 126. In the illustrated example of FIG. 10, the loader 134 loads a record from the initial segment of the sorted list into a highest available slot or position of the main container 128 (block 1000). For the first record to be loaded (e.g., the requested record that initiated the display of the sorted list), the highest available position in the main container 128 is the top position (e.g., slot ‘1’ in the example of FIG. 3). The example loader 134 loads the next record in the lowest available position of the top container 126 (block 1002). For the second record to be loaded (e.g., one of the records of the sorted list immediately adjacent to the requested record), the lowest available position in the top container 126 is the bottom position (e.g., slot ‘2’ in the example of FIG. 3). The example loader 134 determines whether the entire initial segment has been loaded into the main and top containers 128 and 126 (block 1004). If records of the initial segment have not yet been loaded (block 1004), control returns to block 1000 and the ping-pong loading technique of the example loader 134 continues. Otherwise, control passes to block 1006 and returns to FIG. 9.

The initial segment of the records that has been loaded into the example display cache 124 of FIG. 2 is displayed on, for example, the display 110 of FIG. 2 (block 904). As shown in FIG. 3, the initial segment is displayed with the example display pointer 132 referring to the top slot of the main container 128. In other words, the record that was retrieved by the user corresponds to the top slot of the main container 128 and the surrounding records of the list (e.g., in according to sorted positions of the records) populate the main container 128 below the retrieved record and the top container 126 above the retrieved record. Further, the loader 134 continues to load the records of the list beyond the initial segment into the example containers 126-130 (block 906). For example, the loader 134 loads the bottom container 130 with records of the list from top to bottom after the initial segment has been loaded into the main and top containers 128 and 126.

In some instances, the user navigates through the displayed list by, for example, scrolling up or down in the list. When the user navigates through the list, thereby changing which segment(s) of the list are displayed, the example display pointer 132 is adjusted accordingly (block 908). When the navigation detector 136 determines that the display pointer has moved into the top container 126 by a threshold amount (e.g., by scrolling up) (block 910), the example container adjuster 138 alters the configuration of the display cache 124 and the containers thereof (block 912). An example implementation of block 912 of FIG. 9 is illustrated in FIG. 11. The example of FIG. 11 begins with the container adjuster 138 deleting the bottom container 130 (block 1100). In the illustrated example, the deletion of the bottom container 130 includes removing the designation of the corresponding portion of the display cache 124 as a container. As a result, in the illustrated example, the records of list that were loaded in the bottom container 130 are no longer loaded in the display cache 124. Further, the example container adjuster 138 changes the designation of the current main container 128 to be the bottom container (block 1102). Further, the example container adjuster 138 changes the designation of the current top container 126 to be the main container (block 1104). Further, the example container adjuster 138 creates a new container and designates the new container as the top container (block 1106). Further, the example loader 134 loads data from the list of records into the new container (e.g., from bottom to top) (block 1108). Control then returns to FIG. 9 (block 1110).

Referring back to block 910 of FIG. 9, if the navigation detector 136 does not detect the display pointer 124 moving into the top container 126 by a threshold amount, the navigation detector 136 determines whether the display pointer 124 has moved into the bottom container 130 by a threshold amount (block 914). When the navigation detector 136 determines that the display pointer 124 has moved into the bottom container 130 by the threshold amount (e.g., by scrolling down sufficiently) (block 914), the example container adjuster 138 alters the configuration of the display cache 124 and the containers thereof (block 916).

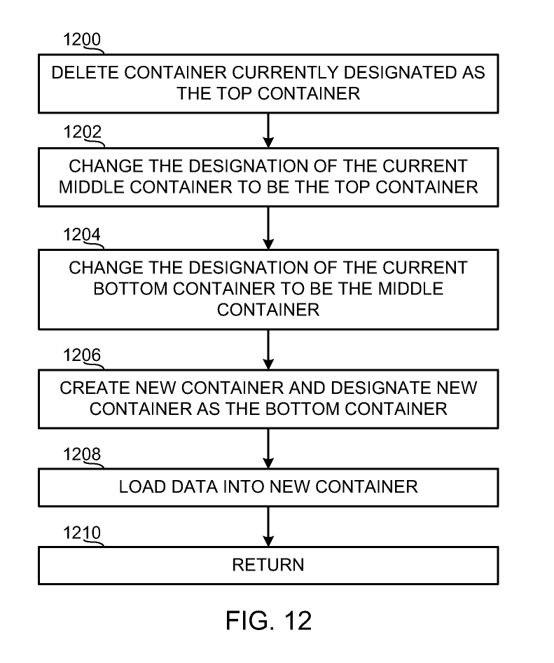

An example implementation of block 916 of FIG. 9 is illustrated in FIG. 12. The example of FIG. 12 begins with the container adjuster 138 deleting the current top container 126 (block 1200). Further, the example container adjuster 138 changes the designation of the current main container 128 to be the top container (block 1202). Also, the example container adjuster 138 changes the designation of the current bottom container 130 to be the main container (block 1204). Moreover, the example container adjuster 138 creates a new container and designates the new container as the bottom container (block 1206). The example loader 134 loads data from the list of records into the new container (e.g., from top to bottom) (block 1208). Control then returns to FIG. 9 (block 1210).

In the example of FIG. 9, the loader 134 determines whether each record of the list has been loaded into the display cache 124 (block 918). If so, control returns to block 906 and the loader 134 continues to load the records into the display cache 124. Otherwise, control returns to block 908 and the segment(s) of the list corresponding to the display pointer 124 are displayed and adjusted as the user navigates the list.

FIG. 13 is a block diagram of an example processor platform 1300 capable of executing the instructions of FIGS. 7-12 to implement the storage manager 100 of FIGS. 1 and/or 2. The processor platform 1300 can be, for example, a desktop computer, a laptop computer, a server, a smart phone, a personal digital assistant (PDA), a tablet, or any other type of computing device.

The processor platform 1300 of the instant example includes a processor 1312. For example, the processor 1312 can be implemented by one or more microprocessors or controllers from any desired family or manufacturer. In the illustrated example, the processor 1312 is to implement at least a portion of the example storage manager 100 of FIGS. 1 and/or 2.

The processor 1312 is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1314, 1316 is controlled by a memory controller.

The example processor 1312 of FIG. 1 includes local memory including the example display cache 124 of FIG. 2. Additionally or alternatively, the example display cache 124 may be implemented in connection with, for example, the volatile memory 1332 of FIG. 13.

The processor platform 1300 also includes an interface circuit 1320. The interface circuit 1320 may be implemented by any type of interface standard, such as an Ethernet interface, a universal serial bus (USB), and/or a PCI express interface.

One or more input devices 1322 (e.g., the input device(s) 106 of FIG. 2) can be connected to the interface circuit 1320. The input device(s) 1322 permit a user to enter data (e.g., a search for a particular record) and commands into the processor 1312. The input device(s) can be implemented by, for example, a keyboard, a mouse, a touchscreen, a track-pad, a trackball, isopoint and/or a voice recognition system.

One or more output devices 1324 (e.g., the output device(s) 108 of FIG. 2) can be connected to the interface circuit 1320. The output devices 1324 can be implemented, for example, by a video card, a video rendering application, display devices (e.g., a liquid crystal display, a touchscreen, and/or speakers). In some examples, the interface circuit 1320 includes a graphics driver card.

The interface circuit 1320 also includes a communication device such as an antenna, a modem or network interface card to facilitate exchange of data with external computers via a network 1326 (e.g., a WiFi network, an Ethernet connection, a digital subscriber line (DSL), a telephone line, coaxial cable, a cellular system, etc.).

The processor platform 1300 also includes one or more mass storage devices 1328, such as a hard drive for storing software and data.

Coded instructions 1332 of FIGS. 7-12 may be stored in the mass storage device 1328, in the volatile memory 1314, and/or in the non-volatile memory 1316.

Although certain example apparatus, system, methods, and articles of manufacture have been disclosed herein, the scope of coverage of this patent is not limited thereto. On the contrary, this patent covers all apparatus, system, methods, and articles of manufacture fairly falling within the scope of the claims of this patent.

What is claimed is:

1. A method of storing data, comprising:
establishing a plurality of containers for storing data representative of a list of records to be displayed on a device; and
loading a first segment of the list of records into first and second ones of the containers by alternating between loading the first container with first data and loading the second container with second data until the first segment is loaded into the first and second containers.

2. A method as defined in claim 1, wherein loading the first container comprises loading the first data into an available position of the first container nearest a first end of the first container.

3. A method as defined in claim 2, wherein loading the second container comprises loading the second data into an available position of the second container nearest a first end of the second container.

4. A method as defined in claim 3, wherein the first end of the first container is adjacent to the first end of the second container.

5. A method as defined in claim 1, wherein loading the first container comprises loading the first container from top to bottom, and wherein loading the second container comprises loading the second container from bottom to top.

6. A method as defined in claim 1, wherein alternating between loading the first container and loading the second container comprises loading the first data into the first container, then loading the second data into the second container, then loading third data into the first container.

7. A method as defined in claim 1, further comprising loading a second segment of the list of records in the containers after the first segment is loaded, wherein the second segment is larger than the first segment.

8. A method as defined in claim 1, further comprising tracking a position within the list corresponding to a displayed record, and changing a designation of the containers when the tracked position moves from the first container into the second container by a threshold amount.

9. An apparatus to store data, comprising:
a first storage container and a second storage container to receive data representative of records of a list, the list to be rendered for display using the records stored in the first and second storage containers; and
a loader to load a first segment of the records into the first and second containers by:
loading the records into the first container in a first direction; and
loading the records into the second container in a second direction opposite the first direction.

10. An apparatus as defined in claim 9, wherein the first direction is from a top position of the first container towards a bottom position of the first container.

11. An apparatus as defined in claim 10, wherein the second direction is from a bottom position of the second container towards a top position of the second container.

12. An apparatus as defined in claim 9, wherein a top position of the first container is adjacent to a bottom position of the second container.

13. An apparatus as defined in claim 9, further comprising a display pointer to track a position in the containers corresponding to a current display of the list of records.

14. An apparatus as defined in claim 13, further comprising an adjuster to change a designation of at least one of the first and second containers in response to the display pointer moving into the first container by a threshold amount.

15. A tangible computer readable storage medium comprising instructions that, when executed, cause a machine to at least:
maintain a pointer indicative of a display position associated with a displayed list of records, wherein data representative of the list of records is stored in first, second, and third memory areas; and
when the pointer moves from the first memory area into the second memory area by a threshold amount:
delete the third memory area;
create a fourth memory area; and
change a first designation associated with the first memory area.

16. A tangible computer readable storage medium as defined in claim 15, the instructions to cause the machine to change the first designation associated with the first memory area by changing the first designation to correspond to the third memory area.

17. A tangible computer readable storage medium as defined in claim 15, the instructions to cause the machine to change a second designation associated with the second memory area to correspond to the first memory area.

18. A tangible computer readable storage medium as defined in claim 15, the instructions to cause the machine to designate the created fourth memory area as the third memory area.

19. A tangible computer readable storage medium as defined in claim 15, the instructions to cause the machine to, when the pointer moves from the first memory area into the third memory area by the threshold amount:
delete the second memory area;
create the fourth memory area; and
change the first designation associated with the first memory area.

20. A tangible computer readable storage medium as defined in claim 19, wherein the first memory area is in between the second and third memory areas.
